(19) United States
(12) Patent Application Publication
(10) Pub. No.: US 2023/0174074 A1
(43) Pub. Date: Jun. 8, 2023

(54) IN-CABIN SAFETY SENSOR INSTALLED IN VEHICLE AND METHOD OF PROVIDING SERVICE PLATFORM THEREOF

(71) Applicant: THINK-I CO., LTD., Seongnam-si (KR)

(72) Inventor: Sung Kuk CHOI, Yongin-si (KR)

(21) Appl. No.: 17/437,321

(22) PCT Filed: Jul. 6, 2021
(86) PCT No.: PCT/KR2021/008555

§ 371 Date: Sep. 8, 2021

(30) Foreign Application Priority Data
Jul. 6, 2020 (KR) 10-2020-0082987

(51) Int. Cl. B60W 40/09; G06V 20/59

(52) U.S. Cl. CPC B60W 40/09; G06V 20/597; B60W 2556/45; B60W 2420/403; B60W 2540/26; B60W 2540/229

(57) ABSTRACT

Disclosed are an in-cabin safety sensor installed in a vehicle and capable of providing a recognition service for drowsy driving and careless driving, and a method of providing a service platform therefor. The in-cabin safety sensor may recognize a state of drowsy driving or careless driving by using an image obtained by photographing a driver. In addition, the in-cabin safety sensor may not only implement immediate response actions, but also provide information on the state information to a service server, so that driver's driving habits and the like may be recorded. In this way, at the level of the service server or a manager thereof, different response actions may be taken for the drowsy driving or careless driving of the corresponding driver of the vehicle.

### TECHNICAL FIELD

The present invention relates to an in-cabin safety sensor installed in a vehicle and, more particularly, to an in-cabin safety sensor and a method of providing a service platform thereof, wherein a service that monitors drowsy driving and careless driving may be provided by using a camera.

### BACKGROUND ART

When a driver is distracted by drowsiness or carelessness while driving a car, the distraction of the driver inevitably leads to an accident. In addition to drowsiness while driving, when the driver neglects to look ahead even for a moment, due to smoking or other distractions while driving, such negligence may cause an accident. Since consequences of the negligence are too great to leave such a situation to attention of an individual driver, development of various driving assistance devices are being developed.

There are several methods for recognizing drowsy driving or careless driving, and a method of analyzing images by photographing a driver with a camera is mainly used, and also another method is used wherein a situation of negligence is recognized by receiving lane departure information from ADAS (Advanced Driver Assistance Systems). The technology applied in these methods is in-cabin sensing. In addition to ADAS, autonomous vehicles require precise information about a driver's focus and what happens inside the vehicle, and in-cabin sensing deals with such requirements. The in-cabin sensor recognizes driver's behavior and gives this information to an ADAS system so that ADAS system may react according to the information.

Meanwhile, by analyzing images photographing a driver's face, especially eye movements, it can be determined whether a driver is drowsy or careless in driving. When a state of drowsiness or carelessness is recognized, ADAS system warns the driver in a visual, auditory, or tactile manner by using the system's own device or an internal system of the vehicle. Even with the warnings provided by the driving assistance system, the condition may not be improved and the driver's state of drowsiness or carelessness may persist. In this case, it may be necessary to transmit the driver's state of drowsiness or carelessness to the outside.

The driving assistance devices related to drowsiness and carelessness may be built into vehicles manufacturing by automobile manufacturers, or may be implemented in a manner in which driving assistance devices are additionally mounted in commercially available automobiles. Most of the additionally mounted driving assistance devices are manufactured to operate as stand-alone devices, and each driving assistance device is implemented to be installed at a position on an upper part of a dashboard or in front of an instrument panel in the driver's seat. The reason is that the installed position is lower than the height of a driver's face, so the position is the best fixed position to photograph the driver's face (especially the eye area). However, as in the related art, when installed at the position on the upper part of the dashboard or in front of the instrument panel, a steering wheel of the vehicle continuously or repeatedly appears on the captured images and interrupts as noise. Nevertheless, the reason why a camera is installed on the dashboard of the instrument panel is that most positions where the steering wheel of the vehicle does not interfere are usually higher than the driver's eyes, so it is not easy to accurately recognize the driver's eyes in the images taken at such a positions.

Meanwhile, since the heights of dashboards and instrument panels are different for each vehicle and relationships between driver's seated heights and steering wheel positions are different for each driver, the driving assistance devices reflecting such differences are specially manufactured for each individual vehicle. Therefore, there is no device that is generally applicable to all automobiles. In general, a distance between a dashboard and a driver's seat of a truck is longer than that of a passenger vehicle. Accordingly, even though applying the angle of view of the normal camera identically, the driver's face appears relatively small in a truck. For this reason, for trucks, it is used a camera with a narrow-angle of view so that a driver's face appears large enough. As such, for example, the driving assistance device is designed and manufactured differently for trucks and passenger vehicles.

### DISCLOSURE

### Technical Problem

An objective of the present invention is to provide an in-cabin safety sensor installed in a vehicle and, more particularly, to provide an in-cabin safety sensor and a method of providing a service platform thereof wherein a service that monitors drowsy driving and careless driving may be provided by using a camera.

### Technical Solution

The in-cabin safety sensor of the present invention for achieving the above objective may be installed on an upper end of a front window of a vehicle to provide a monitoring service for a driver's drowsy driving state or careless driving state. The in-cabin safety sensor of the present invention includes: a communication part capable of accessing the Internet to which the service server is connected, either directly or via other devices; a GPS module configured to generate location information of the vehicle; an infrared LED configured to illuminate a driver; a camera configured to generate an infrared image by photographing the driver; a driving data generator configured to generate driving data of the vehicle on the basis of the location information; and a controller. The controller may recognize a state of a face and eye part by performing image processing on an image input from the camera at a preset frame rate when it is confirmed on the basis of the driving data that the vehicle is driving, so as to generate an event when a driver's drowsy driving state or careless driving state is confirmed, thereby providing the event to the service server.

Generating an Event

According to an exemplary embodiment, the controller includes an image processor and an event generator. The image processor generates first recognition information whenever an image on which driver's eyes closed is recognized by processing the images being inputted at the preset frame rate and to provide the first recognition information to an event generator. The event generator generates a first event related to driver's drowsy driving when the first recognition information is continuously confirmed for a preset first reference time or longer.

According to the exemplary embodiment, the image processor generates second recognition information whenever recognizing an image that the driver is looking in a direction other than forward. In this case, the event generator may generate a second event for driver's careless driving and provides the second event to the service server when a condition in which the second recognition information is confirmed for a preset second reference time or longer is repeated for a preset reference number of times or more.

According to another exemplary embodiment, on the basis of the driving data, when it is confirmed that the vehicle is driving at a speed greater than or equal to a preset speed, the event generator may recognize the state of the face and eye part by performing the image processing on an image input from a first camera at the preset frame rate, so as to generate the event when the driver's drowsy driving state or careless driving state is confirmed.

Setting a Camera

According to yet another exemplary embodiment, the controller may further include a camera setting part. a camera setting part may calculate, in a setting mode, a size of a face area from an original image generated by photographing the driver, and then calculate a magnification corresponding to a difference obtained by comparing the size with a preset size and, so as to set a zoom parameter. In this case, preferably, the image processor may perform the image processing on the basis of an image in which the size of the face area of the driver is adjusted to a predetermined size range by enlarging or reducing an image provided by the camera according to the zoom parameter.

According to still another exemplary embodiment, the camera setting part may control to recognize, in the setting mode, at least one window area disposed relative to a left and right of the driver from the image provided by the camera through the image processing, so as to set the window area as an unprocessed area. The camera setting part may control to adjust, in a monitoring mode, white balance of the camera by a calculated white balance value excluding the unprocessed area from the image provided by the camera.

The present invention also extends to a method of providing a service platform of an in-cabin safety sensor. The method of providing a monitoring service for drowsy driving and/or careless driving includes: generating an infrared image by emitting infrared rays to a driver by an infrared LED and photographing the driver by a built-in camera; determining whether the vehicle is driving by generating location information of the vehicle by a GPS module and generating driving data of the vehicle by a driving data generator on the basis of the location information; and performing, by an image processor on the basis of the driving data, image processing on an image input from the camera at a preset frame rate when it is confirmed that the vehicle is driving and generating an event when the driver's drowsy driving state or careless driving state is confirmed by recognizing the state of a face and eye part to provide the event to a service server by connecting to the Internet through a communication part.

### Advantageous Effects

The in-cabin safety sensor of the present invention photographs a driver by using the in-cabin safety sensor installed in a vehicle and recognizes the type of drowsy driving or careless driving through image processing for the photographed images.

In this case, since the in-cabin safety sensor of the present invention may be installed at any position such as an upper part in front of the driver besides a dashboard of the vehicle and may obtain images sufficient to recognize driver's motion by automatically setting a zoom parameter according to a distance between the installed position and the driver, the images suitable for image processing may be obtained without considering the distance between the installed position of the in-cabin safety sensor and the driver.

In addition, the in-cabin safety sensor of the present invention detects, in captured images, a vehicle's window area that affects white balance of the driver's images, and excludes pixel values of the corresponding window area when adjusting the white balance, whereby the images suitable for image processing may be automatically generated.

When drowsy or careless driving is recognized, the in-cabin safety sensor automatically provides response actions to help a driver focus on driving, the response actions including outputting a warning sound, making a phone call to a driver's mobile terminal, giving the driver to voices of his or her family members, or the like.

Meanwhile, among driver's driving habits recognized according to the present invention, driving states of drowsiness, various carelessness, or the like are continuously accumulated and recorded in a service server, so that the recorded driving states may be utilized as data for analyzing the driver's driving habits.

For example, in connection with an insurance company server connected to the service server of the present invention, the driver's driving habits may be used to allow insurance premiums to be automatically adjusted on the basis of accumulated driving habits of the driver, or may be used as a material for safety education on driving habits for the driver who works for a company and drives a company vehicle, or may contribute to improving driving habits of the driver by applying deduction points and the like whenever drowsy or careless driving is identified. In this way, the present invention may significantly contribute to reducing traffic accident rates.

### DESCRIPTION OF DRAWINGS

FIG. 1 is a block diagram showing an in-cabin safety sensor and a service server of the present invention.

FIG. 2 is a view showing an example of a vehicle in which the in-cabin safety sensor of the present invention is installed.

FIG. 3 (a), FIG. 3(b), FIG. 3(c) and FIG. 3(d) is an example of infrared images used for a monitoring service for driving.

FIG. 4 is a flowchart illustrating a monitoring service for drowsy driving and careless driving according to an exemplary embodiment of the present invention.

### BEST MODE

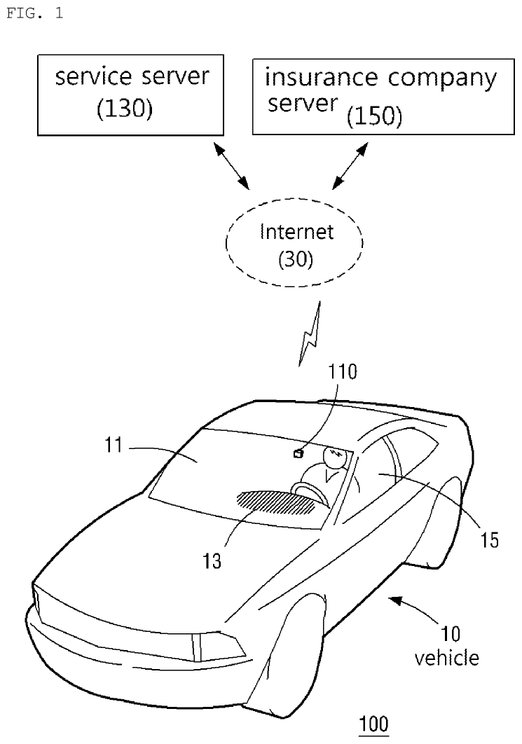

Referring to FIG. 1, a service system 100 of the present invention includes: an in-cabin safety sensor 110 installed inside a vehicle; and a service server 130 and an insurance company server 150, which are connected to each other through the Internet 30, wherein comprehensive services related to driver's drowsy driving and careless driving are provided. Here, the Internet 30 is the Internet widely known in the related art.

According to an exemplary embodiment, the service system 100 may further include a driver's mobile terminal (not shown) such as a wireless phone or a tablet. The driver's mobile terminal (not shown) is provided with a communication means that may be individually connected to the Internet 30 and the in-cabin safety sensor 110, and while serving to connect the in-cabin safety sensor 110 and the Internet 30 to each other, may receive a warning message and the like as described below according to the exemplary embodiment.

The in-cabin safety sensor 110 is installed in the vehicle 10 to generate images for recognizing the driver's drowsy driving and careless driving and configured to generate driving data described below. In addition, together with a service server 130 connected to the Internet 30, the in-cabin safety sensor 110 provides a warning service for drowsy driving and careless driving according to the present invention.

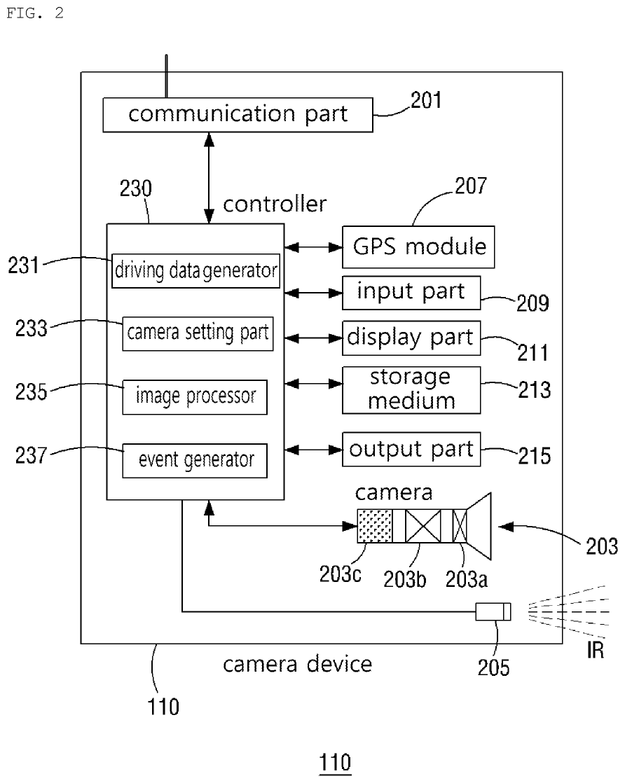

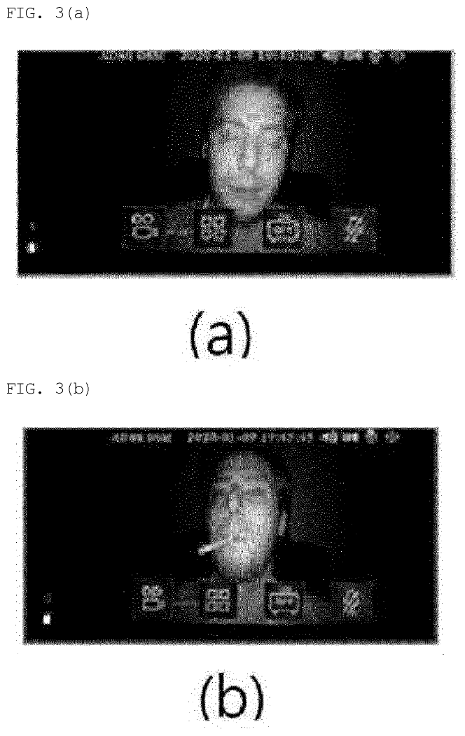

Referring to FIG. 2, the in-cabin safety sensor 110 includes: a communication part 201, a camera 203, an infrared LED 205, a GPS module 207, an input part 209, a display part 211, a storage medium 213, an output part 215, and a controller 230. The in-cabin safety sensor 110 may be implemented integrally by embedding the entire components of a configuration in a single case, as shown in FIG. 2, or may be implemented in a form in which the camera 203 is separated.

The power supply (not shown) provides DC operating power for operation of the in-cabin safety sensor 110. The power supply may use a built-in battery as a main power source, but may also receive DC power (V+) of the vehicle 10 through a fuse box (not shown) of the vehicle 10 to supply DC operating power.

The communication part 201 is a wireless network means for accessing the service server 130, and any type of communication means that is capable of connecting to the Internet 30 is applicable. For example, the communication part 201 may be a means for connecting to a mobile communication network such as a general LTE or 5G network, and may also be a means for accessing a low-power broadband network such as LoRa, Sigfox, Ingenu, LTE-M, NB-IoT, etc. In addition, in a case where the service system 100 of the present invention further includes a driver's mobile terminal (not shown) connecting the in-cabin safety sensor 110 and the Internet 30 to each other, the communication part 201 may be wireless LAN or Bluetooth, and the like, which are connectable to the driver's mobile terminal.

The communication part 201 may even transmit still images or moving picture files, which are captured by the camera 203, to the service server 130 according to the bandwidth allowed by its own communication method. For example, in the case of the low-power broadband network, it is difficult to transmit moving picture files, but instead transmit still images.

As a means for recognizing driver's drowsy driving and careless driving, the camera 203 generates infrared images by photographing a driver, and to this end, the camera 203 is provided with an infrared filter 203a, a lens 203b, and an image sensor 203c.

The image sensor 203c generates infrared images by capturing infrared rays incident through the infrared filter 203a. The image sensor 203c should have the resolution sufficient to enable an image processor 235 to analyze driver's behavior through image processing. In addition, as described below, the image sensor 203c should be provided with resolution sufficient to the extent that allows drowsiness and/or careless driving to be identifiable by recognizing the movement of the driver's eyes or mouth even in enlarged or reduced images processed by using a zoom parameter. Although it is preferable that the camera 203 has an optical system for zooming, which is not practically applicable considering the high cost and difficulty in miniaturization thereof, it is preferable to apply a so-called “digital zoom” that enlarges or reduces digital images. Therefore, the resolution of the image sensor should be of the resolution sufficient to perform image processing of the driver's face images, even when the images are enlarged or reduced by the zoom parameter selected in a setting mode.

The infrared filter 203a is a band-pass filter that passes infrared rays, and mainly passes infrared rays from light incident to the image sensor 203c. The infrared LED 205 used to generate infrared images in the present invention uses wavelengths of approximately 850 nm to 940 nm, but among the wavelengths, the infrared filter 203a may filter infrared rays of a specific wavelength band according to setting of center frequency and bandwidth.

Unlike the related art, the camera 203 is installed on a front window 11 of a vehicle 10. The upper part of the front window 11 facing a driver's seat is suitable for photographing a driver. Since the camera 203 is installed on the upper part of the front window 11, the driver may be photographed in a state where there is no obstacle between the camera 203 and the driver. Since the camera is not installed on the upper part of a dashboard 13 of the driver's seat as in the related art, there is no problem that the steering wheel of the vehicle or hands and arms of the driver appear repeatedly in images or appear in the images in a fixed state at all times.

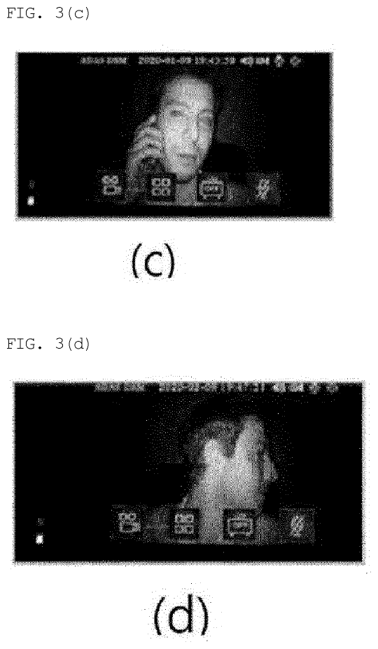

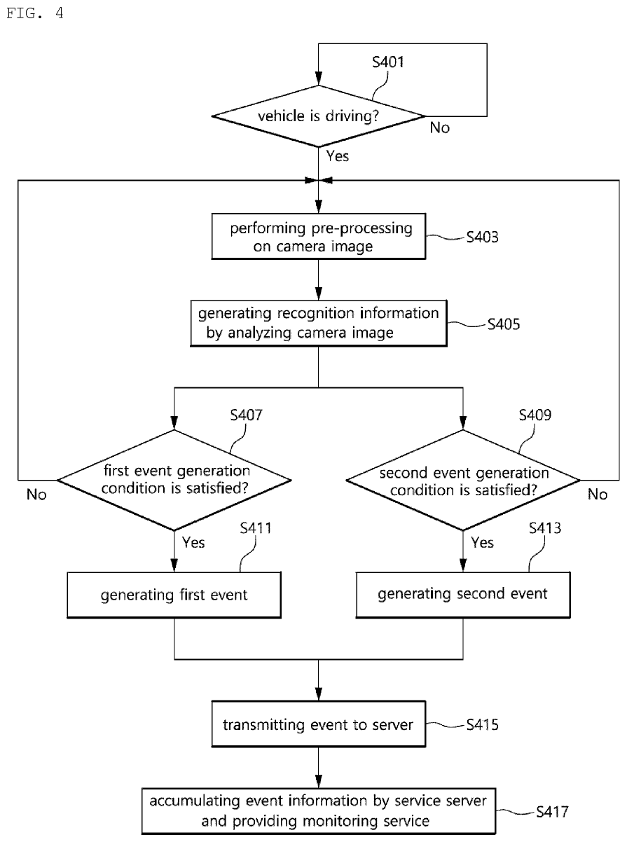

However, when the camera is installed at the position of the upper part in front of the driver, it is difficult to recognize driver's motion, especially the blinking of the eyes. In order to solve this problem, by using a deep learning engine of artificial intelligence technology, it is possible to analyze images at times when the size and angle of the recognized face are changed, being taken from the position of the upper part in front of the driver, but to this end, it is necessary to provide a high-performance processor due to the fact that high computational processing is required for deep learning. In the present invention, in order to solve this problem without using the high-performance processor, the camera 203 is designed to generate infrared images. In addition to being usable without distinction at both day and night, as illustrated in FIG. 3, infrared images have an effect of removing particular parts from images around the face. Accordingly, the image processor 235 below may process the images very easily. In addition, since the infrared image has characteristics in which contours of the eyes and nose are clear and noise in the infrared image is removed, the infrared image is advantageous in recognizing the driver's motion.

The infrared LED 205 emits infrared rays toward a driver so that the camera 203 may take infrared images. Infrared rays may use the wavelength band of approximately 850 nm to 940 nm. While the infrared LED 205 illuminates a driver, the camera 203 obtains infrared images as shown in FIG. 3 with infrared rays reflected from the driver.

The GPS module 207 receives GPS signals from a GPS satellite and provides the signals to the controller 230. In FIGS. 1 and 2, the GPS module 207 is shown as a component, in the view of the configuration, built into the in-cabin safety sensor 110, but according to an exemplary embodiment, the GPS module 207 may be implemented as a separate component connected with the in-cabin safety sensor 110.

The input part 209 receives various control commands from a driver like a button. The display part 211 corresponds to an LCD, OLED, and the like that may visually display various information according to control of the controller 230. The display part 211 may display the images captured by the camera 203. The storage medium 213 stores all or part of the infrared images captured by the camera 203, and an SD card and the like may be used therefor. The output part 215 outputs sounds such as voice or beep sounds, or outputs event signals to an external device (e.g., vibrating seat).

The controller 230 controls the overall operation of the in-cabin safety sensor 110 of the present invention. Accordingly, the controller 230 performs a function of infrared imaging and recording by using the camera 203, and performs a function of detecting drowsy driving and careless driving, the functions being unique to the present invention. In order to perform the function of the present invention detecting and preventing drowsy driving and careless driving, the controller 230 includes: a driving data generator 231, a camera setting part 233, an image processor 235, and an event generator 237.

The driving data generator 231 generates “driving data” such as locations (i.e., coordinates), speed, and driving directions of vehicles by using signals provided by the GPS module 207. The driving data is used to confirm whether the vehicle 10 is in driving for an in-driving service of the present invention to be described below. The method for the driving data generator 231 to calculate driving data by using the GPS signals may be implemented by any number of methods known in the related art.

The camera setting part 233 supports image preprocessing of the image processor 235 by setting the “zoom parameter” and “unprocessed area” in the setting mode of the camera 203. Here, the zoom parameter is an enlargement (or reduction) ratio applied to the preprocessing of original images captured by the camera 203, and the image processor 235 enlarges or reduces the original images generated by the camera 203 according to the zoom parameter, so as to obtain driver-centric images while maintaining resolution suitable for recognizing drowsy driving and/or careless driving, and then performs, on the driver's face area, image processing for recognizing drowsy driving or careless driving to store the images in the storage medium 213. Since the problem is that sizes of the driver's face images are smaller than a reference size, generally the zoom parameter should be the enlargement ratio rather than the reduction ratio.

In each image captured by the camera 203, the unprocessed area refers to an area occupied by the window 15 positioned in the left and right direction of the driver's seat of the vehicle 10. When controlling the white balance for the images generated by the camera 203, the image processor 235 adjusts the white balance of the images generated by the camera 203 by using pixel values of the remaining areas except for the pixel values of the unprocessed area. Since a significant amount of infrared light is also included in natural light incident through the window 15 of a vehicle during the day, an infrared image captured by the camera 203 during the day becomes an overall bright image. Accordingly, when the white balance is adjusted on the basis of the pixel values of all pixels, the driver's face area is adjusted to be relatively dark, whereby image processing may be made impossible. Whereas, there is no natural light at night, but since the window area of the vehicle in an infrared image is a very dark area, when adjusting the white balance on the basis of the pixel values of all pixels, the driver's face area may be saturated with a very bright color, whereby the image processing may be made impossible. Therefore, when adjusting the white balance, the “unprocessed area” is set so that pixel values of the window 15 area of the vehicle are excluded. A method of setting the “zoom parameter” and “unprocessed area” of the camera setting part 233 will be described in detail below.

For the original images provided by the camera 203 at a preset frame rate (e.g., 30 FPS), the image processor 235 (1) generates pre-processed and enlarged (or reduced) images by using the zoom parameter calculated by the camera setting part 233, (2) performs recognizing of objects necessary for determination of drowsy driving or careless driving on the basis of the enlarged (or reduced) images, and then (3) provides, to the event generator 237, recognition information including the recognized result.

In order to recognize objects necessary for the determination of drowsy driving and careless driving, the image processor 235 performs image processing for all images provided by the camera 203, so as to recognize not only the driver's face and eyes, but also other major objects of interest (e.g., cigarette, wireless phone, etc.). According to the exemplary embodiment, under control of the event generator 237, the image processor 235 may perform such image processing only when a vehicle is driving.

A method for the image processor 235 to recognize objects and motion of the objects in each individual video has been previously developed and widely known, and in the present invention, a conventionally well-known image processing technique may be used as it is. Meanwhile, since a pre-processed infrared image has almost no image information other than a face part and the outlines of face and eyes are distinct, recognizing a driver's face and recognizing eye movements is relatively easy, compared to different recognition processes using a color image.

By using driving data provided by the driving data generator 231, the event generator 237 determines whether a vehicle 10 is driving, and only when the vehicle is driving, monitoring events related to the monitoring service for drowsy driving and careless driving are generated. By using the communication part 201 to access the Internet 30 directly or indirectly via other means, the event generator 237 provides the generated monitoring event (or information thereof) to the service server 130.

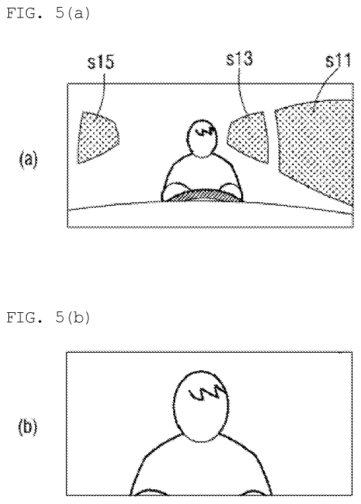

The monitoring event includes: (1) a first event for determining a driver's drowsy driving state; and/or (2) a second event for determining driver's careless driving state. Hereinafter, a method of providing the monitoring service of the present invention for drowsy driving and careless driving, the monitoring service being performed by the event generator 237, will be described in detail with reference to FIG. 4.

<Determining Whether a Vehicle is Driving: S401>

The event generator 237 periodically receives signals provided by the GPS module 207 to generate driving data of a vehicle 10 and determine whether the vehicle 10 is driving, so that when the vehicle 10 is driving, the event generator 237 enters “monitoring mode” for monitoring drowsy driving and/or careless driving.

According to exemplary embodiment, the event generator 237 may determine whether the vehicle 10 is driving at a speed greater than or equal to a predetermined speed. For example, when a driver's face is turned leftward or rightward, or rearward to park the vehicle, a forward-gaze neglect event may be generated. But in a condition where the vehicle speed is greater than or equal to 30 km, the monitoring event is not generated during parking. Similar GPS speeds may be applied to event action scenarios such as drowsy driving, cell phone calling, and smoking.

<Preprocessing for Camera Image: S403>

The infrared LED 205 is turned on, and the camera 203 generates infrared images at a preset frame rate, so as to provide the infrared images to the image processor 235.

The image processor 235 performs pre-processing of the enlargement (or reduction) of the original images, provided by the camera 203 at the preset frame rate, at a regular rate by using the zoom parameter calculated by the camera setting part 233, thereby generating enlarged (or reduced) images. Referring to FIG. 5, FIG. 5(a) is a view showing an original image generated by the image sensor 203c of the camera 203, FIG. 5(b) is a view showing an image enlarged by pre-processing by the image processor 235 according to a zoom parameter, and FIG. 3 is a view showing actual infrared images generated by the same process as in FIG. 5(b).

<Analyzing Images by Using Preprocessed Images: S405>

The image processor 235 first recognizes not only a driver's face and eyes, but also the other major objects of interest (i.e., cigarette, wireless phone, etc.) in the pre-processed images. For images in which faces, eyes, and the other objects of interest are recognized, the image processor 235 finally recognizes about: whether the eyes are closed; whether the faces or eyes are looking elsewhere other than forward; and whether the cigarette or cordless phone is recognized, and provides the recognition information to the event generator 237. In the example of FIG. 3, FIG. 3(a) is an example of photographing a driver closing his eyes due to drowsiness, FIG. 3(b) is an example of photographing the driver smoking a cigarette while driving, FIG. 3(c) is an example of photographing the driver making a phone call while driving, and FIG. 3(d) is an example of photographing the driver looking in a direction other than forward while driving.

Meanwhile, the image processor 235 may provide recognition information for all images by generating the recognition information even when the monitoring objects are not recognized from the images, or may provide the recognition information only when there are recognized results. According to the exemplary embodiment, the image processor 235 may not perform image processing on all images provided by the camera 203, but process the camera image only during the monitoring mode to generate recognition information. In any case, the recognition information is provided in units of one image.

<Determining Whether the Condition for a First Event or a Second Event are Made: S407 or S409>

When a vehicle is driving, the event generator 237 determines a condition for generating a first event and/or a second event by accumulating and analyzing recognition information provided by the image processor 235. The condition for generating the first event and the second event may be variously set.

The first event may be determined by, for example, whether a state in which eyes are closed continues for more than a first reference time (e.g., three seconds). When the state with eyes closed continues for three seconds or more, it is determined as drowsy driving, and in a case where the camera 203 generates images at 30 frames per second (i.e., fps=30), the event generator 237 may determine the first event as drowsy driving, when “first recognition information” indicating that the driver closes his/her eyes is continually confirmed in the recognized results of the continuous 90 frame images.

For example, when a state in which a face is looking in a direction other than forward for a second reference time (e.g., two seconds) or more is repeated more than a reference number of times (e.g., four or more), the second event may be set as careless driving. When “second recognition information” in which a driver is looking elsewhere is continually identified from the recognized result of the continuously provided 60 frames of images (i.e., images for two seconds) and provision of the same/similar type of recognized result is repeated four or more times within a predetermined time range, the event generator 237 may determine this event as careless driving.

In addition, for example, when a cigarette or a mobile phone is continuously or discontinuously recognized for more than a third reference time (e.g., 10 seconds), this event may be set to correspond to careless driving. For example, when “third recognition information” in which a cigarette or mobile phone is continuously or discontinuously recognized from a recognized result of 300 frames of images (i.e., images for 10 seconds) is confirmed, the event generator 237 may determine this event as careless driving.

<Generating the First Event or the Second Event: S411 or S413>

When a determined result in step S407 corresponds to a first event generation condition or a second event generation condition, the event generator 237 generates a first event and/or a second event.

<Transmitting the First Event or the Second Event to the Service Server: S415>

While storing the first event and/or the second event in the storage medium 213, the event generator 237 transmits the first event and/or the second event to the service server 130 by using the communication part 201.

In a case of the first event, the event generator 237 generates first event state information for confirming a drowsy driving state, and provides, to the service server 130, the entire image (i.e., video) in which the corresponding first event occurred, or some of still images from the entire image.

In a case of the second event, the event generator 237 generates second event state information for confirming a careless driving state, and provides, to the service server 130, the entire image (i.e., video) in which the corresponding second event occurred, or some of still images from the entire image. Since there are several types of the second event, the content of the second event state information may also be set differently according to the type of careless driving.

According to the exemplary embodiment, the first event state information and the second event state information may include vehicle driving data (i.e., locations, speed, direction information, etc.) calculated by the driving data generator 231.

Meanwhile, in addition to providing event information to the service server 130, the event generator 237 may perform an emergency response action according to the first event and/or the second event. For example, the event generator 237 may output alarm messages or pre-stored voices, and may turn on a special light to remind the driver to pay attention.

<Accumulating Event Information in the Service Server: S417>

When receiving the first event status information and/or the second event status information periodically or aperiodically from each in-cabin safety sensor 110, the service server 130 stores and manages the information in an internal data server, and performs fundamental response actions.

In addition, the service server 130 may generate driver data by using the first event state information and the second event state information, which are collected from a specific in-cabin safety sensor (or specific driver) over a long period of time.

In the above method, the monitoring service for drowsy driving and careless driving is performed by the event generator 237 of the present invention. According to the generation of the first event and the second event, the controller 230 or the service server 130 may take various accident prevention actions.

Generating a Zoom Parameter

The camera setting part 233 calculates a zoom parameter when the in-cabin safety sensor 110 is in the setting mode.

The camera setting part 233 calculates the size of the face area from the original image like FIG. 5(a) that is generated by photographing the driver, and then compares the size with a preset size so as to calculate a magnification by the difference, whereby a zoom parameter may be obtained.

Setting an Unprocessed Area for White Balance

The camera setting part 233 sets the “unprocessed area” on the basis of the image generated by photographing the driver during the daytime, like FIG. 5(a). To this end, the camera setting part 233 recognizes at least one window area S11, S13, and S15, which are disposed relative to the left and right of the driver, from the infrared image as shown in FIG. 5(a) through image processing, so as to set the window area as the “unprocessed area”.

During the monitoring mode, the camera setting part 233 controls to periodically provide the white balance value calculated from the image in which the unprocessed area is excluded, to the camera 203, so as to adjust the white balance.

Alternatively, when the pixel values of the entire image are saturated to the extent that the image processor 235 is unable to recognize the driver's eyes and the like, the camera setting part 233 may control to provide the re-calculated white balance value excluding the unprocessed area to the camera 203, so as to adjust the white balance.

Exemplary Embodiment: Service Server

By the in-cabin safety sensor 110 of the present invention, the service server 130 operates the monitoring service for drowsiness/careless driving as a whole and may register and manage the driver for the service thereof. Through the driver registration, the service server 130 stores and manages a black box identification number and driver information by matching each other. Here, the driver information includes not only fundamental information such as a driver identification number, login ID and password, and vehicle number, but also information such as phone number and MAC address of the driver's portable terminal.

In relation to the monitoring service for drowsiness/careless driving, response actions that the service server 130 may perform are as follows.

(1) Taking Immediate Response Actions to Remind the Driver to Pay Attention

First, when receiving the first event state information and the second event state information, the service server 130 may take actions to remind the driver to pay attention in order to prevent accidents.

The service server 130 may control to transmit and output a preset warning message or voice to the in-cabin safety sensor 110, or may make a call to the driver's mobile phone (not shown), or may call a pre-stored third party to notify the corresponding case as well.

(2) Analyzing Driver Driving Habits on the Basis of Big Data

The service server 130 may generate comprehensive “driver driving information” about the driver's driving habits and behavior patterns by using the first event state information and the second event state information, which are stored for a long period of time. The data generated in this way may also be used as re-education materials related to the driver's driving habits.

Meanwhile, when a vehicle accident occurs during the first event or the second event, the first event status information and the second event status information, which are stored and managed by the service server 130, and the additionally stored images or videos may be used as data to determine whether drowsy/careless driving has caused the vehicle accident.

For example, the service server 130 may record deduction points for the corresponding driver. When the first event status information is received, two points are deducted, and when the second event status information is received, one or two points are deducted, and so on. The deduction points stored for a predetermined period in this way may be used as a means for re-educating of the driving habits of the corresponding driver. The service server 130 transmits the accumulated deduction points of the driver back to the in-cabin safety sensor 110 and the user's mobile phone so that the driver may check the accumulated deduction points.

(3) Interworking with Insurance Company Server

The service server 130 may provide “driver driving information” and/or accumulated deduction points for a specific driver to the insurance company server 150, and the insurance company server 150 may automatically apply a premium surcharge or premium discount according to a car insurance contract with the corresponding driver.

In the above, the preferred exemplary embodiments of the present disclosure have been illustrated and described, but the present disclosure is not limited to the specific exemplary embodiments described above. In the present disclosure, various modifications may be possible by those skilled in the art to which the present disclosure belongs without departing from the spirit of the present disclosure claimed in the claims, and these modifications should not be understood individually from the technical ideas or prospect of the present disclosure.

1. An in-cabin safety sensor installed in a vehicle and connected to an external service server configured to provide a service platform, the in-cabin safety sensor comprising:
a communication part capable of accessing the Internet to which the service server is connected, either directly or via other devices;
a GPS module configured to generate location information of the vehicle;
an infrared LED configured to illuminate a driver;
a built-in camera configured to generate an infrared image by photographing the driver;
a driving data generator configured to generate driving data of the vehicle on the basis of the location information; and
a controller configured to recognize a state of a face and eye part by performing image processing on an image input from the camera at a preset frame rate when it is confirmed on the basis of the driving data that the vehicle is driving, so as to generate an event when a driver's drowsy driving state or careless driving state is confirmed, thereby providing the event to the service server.

2. The in-cabin safety sensor of claim 1, wherein the controller comprises:
an image processor configured to generate first recognition information whenever an image on which driver's eyes closed is recognized by processing the images being inputted at the preset frame rate and to provide the first recognition information to an event generator; and
the event generator configured to generate a first event related to driver's drowsy driving when the first recognition information is continuously confirmed for a preset first reference time or longer.

3. The in-cabin safety sensor of claim 2, wherein, the image processor generates second recognition information whenever recognizing an image that the driver is looking in a direction other than forward, and
the event generator generates a second event for driver's careless driving and provides the second event to the service server when a condition in which the second recognition information is confirmed for a preset second reference time or longer is repeated for a preset reference number of times or more.

4. The in-cabin safety sensor of claim 2, wherein, on the basis of the driving data, when it is confirmed that the vehicle is driving at a speed greater than or equal to a preset speed, the event generator recognizes the state of the face and eye part by performing the image processing on an image input from a first camera at the preset frame rate, so as to generate the event when the driver's drowsy driving state or careless driving state is confirmed.

5. The in-cabin safety sensor of claim 2, wherein the controller further comprises:
a camera setting part configured to calculate, in a setting mode, a size of a face area from an original image generated by photographing the driver, and then calculate a magnification corresponding to a difference obtained by comparing the size with a preset size and, so as to set a zoom parameter; and
the image processor configured to perform the image processing on the basis of an image in which the size of the face area of the driver is adjusted to a predetermined size range by enlarging or reducing an image provided by the camera according to the zoom parameter.

6. The in-cabin safety sensor of claim 5, wherein the camera setting part controls to recognize, in the setting mode, at least one window area disposed relative to a left and right of the driver from the image provided by the camera through the image processing, so as to set the window area as an unprocessed area, and controls to adjust, in a monitoring mode, white balance of the camera by a calculated white balance value excluding the unprocessed area from the image provided by the camera.

7. A method of providing a service platform of an in-cabin safety sensor installed in a vehicle, the method comprising:
generating an infrared image by emitting infrared rays to a driver by an infrared LED and photographing the driver by a built-in camera;
determining whether the vehicle is driving by generating location information of the vehicle by a GPS module and generating driving data of the vehicle by a driving data generator on the basis of the location information;
performing, by an image processor on the basis of the driving data, image processing on an image input from the camera at a preset frame rate when it is confirmed that the vehicle is driving; and
generating an event, by an event generator, when the driver's drowsy driving state or careless driving state is confirmed by recognizing the state of a face and eye part through the image processing and providing the event to a service server by connecting to the Internet through a communication part.

8. The method of claim 7, further comprising:
setting, by a camera setting part of the controller in a setting mode, a zoom parameter by calculating a size of a face area from an original image generated by photographing the driver, and then calculating a magnification by a difference obtained by comparing the size with a preset size,
wherein, in the performing of the image processing, the image processor enlarges or reduces the image provided by the camera according to the zoom parameter and performs the image processing on the basis of an image obtained by adjusting the size of the face area of the driver to a predetermined size range.

9. The method of claim 8, further comprising:
recognizing, by the camera setting part in the setting mode, at least one window area disposed relative to a left and right of the driver from the image provided by the camera through the image processing, so as to set the window area as an unprocessed area; and
controlling, in a monitoring mode, the camera setting part to adjust white balance of the camera by a white balance value calculated by excluding the unprocessed area from the image provided by the camera.
